(19) United States
(12) Patent Application Publication
(10) Pub. No.: US 2006/0033301 A1
(43) Pub. Date: Feb. 16, 2006

(54) Suspension method and system for compensation of lateral pull on a vehicle with a virtual pivot

(75) Inventors: Gijsbert Roos, Clermont-Ferrand (FR); Philippe Souyri, Saint-Genes-Du-Retz (FR)

Correspondence Address: Thomas Langer;COHEN, PONTANI, LIEBERMAN & PAVANE, Suite 1210, 551 Fifth Avenue, New York, NY, 10176, US

(73) Assignee: Michelin Recherche et Technique S.A., Granges-Paccot (CH)

(21) Appl. No.: 11/203,773

(22) Filed: Aug. 15, 2005

Related U.S. Application Data
(63) Continuation of application No. PCT/EP04/01433, filed on Feb. 16, 2004.

(30) Foreign Application Priority Data
Feb. 17, 2003 (FR) 03/01902

(51) Int. Cl. B60G 9/00

(52) U.S. Cl. 280/124.125

(57) ABSTRACT

A technique for compensating side pull in a vehicle, the suspension system of the steering axle of the said vehicle comprising a virtual pivot point. The method applies a steering torque (Cg) to the wheel-carrier (2g) by way of one of the arms (5g, 6g) of the virtual pivot point.

The present invention deals with the ground contact system of vehicles, in particular suspension devices, and more particularly with the balance of the steering system of steering axles having virtual pivot points. Steering axles having virtual pivot points are those axles having at least one “triangle” formed by two arms connecting different points on the body to different points on the wheel-carrier. U.S. Pat. No. 4,863,188 describes an example of a steering system of this kind. In that patent, the example suspension system has two triangles (lower and upper) each defining a virtual pivot point.

Generally, the term “side pull” is used to mean the tendency a vehicle may have to deviate from travel in a straight line in the absence of any driver operation of the steering wheel. Side pull may have numerous different causes, and these causes are often combined with one another. For example, side pull may result from poorly adjusted suspension (toe in, camber, caster, caster angle), tyres which are faulty, different, badly inflated or inappropriate, an imbalance in the steering system, wind or a transverse inclination of the road.

Side pull associated with an inclination of the road is a well-known problem. Generally speaking, roads have a transverse inclination, known as banking, which is intended to facilitate water run-off. This inclination tends to cause vehicles, because of the caster, to drift to the lowest side of the road, that is to say towards the outside of the road. Caster is useful in stabilising the steering system, but it makes the steering system sensitive to lateral forces acting on the vehicle. This tendency to drift means the driver is obliged to exert effort on steering the vehicle in order to keep travel in a straight line. Vehicle and tyre manufacturers take account of this tendency when designing the vehicle. This is why designs of asymmetrical suspensions capable of compensating this tendency have been drawn up. Similarly, some tyre architectures allow a slight side pull to be generated which, if oriented in the opposite direction to that caused by the banking, may minimise or cancel the force required on the steering wheel to keep travel in a straight line.

In Europe, where the vast majority of vehicles are designed to drive on the right-hand side of the road (this is called “driving on the right”), their design and/or the choice of their tyres are such that side pull associated with an average banking towards the right-hand side of a road can be compensated. However, this configuration is not generally reconsidered for those parts of the market (such as the United Kingdom) where vehicles drive on the left-hand side of the road (this is called “driving on the left”). The problem of side pull associated with banking of the road then becomes more acute, since the corrections made to compensate side pull towards the right inevitably worsen side pull towards the left. This situation is uncomfortable for the driver, who has to exert a constant force on the edge of the steering wheel of the vehicle in order to keep the vehicle in a straight line. Nonetheless, the size of these markets does not justify the specific development of fundamentally different vehicles. Similarly, tyre manufacturers are unwilling to market locally tyres which cause reverse side pull, on the one hand because of the low demand and on the other because of the difficulty in controlling the final destination of products in a European market ruled by the free movement of goods.

The situation described here by way of illustration is not limited to the European market. Other markets have the same problem or the opposite problem. On the other hand, what is described here for the (worst) case of vehicles designed and equipped to compensate side pull is just as true, of course (although to a lesser extent) for a vehicle designed and equipped with tyres for neutral behaviour, for an unbanked road, and which is to be adapted for a market with driving on the right or on the left.

WO 01/56819, which deals with this same question of compensation of side pull, proposes a solution for vehicles equipped with MacPherson steering axles. The solution proposed in that document is not applicable to suspension systems other than MacPherson ones.

It is an object of the invention to provide a solution applicable to the case of steering axles having a virtual pivot point. These axles may, however, also use a MacPherson strut.

The invention relates to a method of compensating side pull in a vehicle, the suspension system of the steering axle of the said vehicle comprising a virtual pivot point, the said method consisting in applying a steering torque to the wheel-carrier by way of one of the arms of the said virtual pivot point.

Preferably, the steering torque is applied to the wheel-carrier in the form of a steering force acting on the point at which the arm is articulated to the wheel-carrier.

Preferably, this steering force is generated by a transverse force acting on the arm.

According to one embodiment, the transverse force is transmitted to the arm by a substantially horizontal spring.

According to another embodiment, the transverse force is transmitted to the arm by a combined spring and shock absorber unit.

Alternatively, the steering force may be generated by a torque acting on the arm.

The method according to the invention may also consist in applying a steering torque to each wheel-carrier of the steering axle respectively, with the two steering torques preferably acting in the same direction.

The invention also relates to a suspension system for a steering axle having a virtual pivot point, in which at least one of the arms of the said virtual pivot point applies a steering torque to the wheel-carrier in the central position of the suspension. The invention also relates to a vehicle comprising this suspension system.

The various principles of the invention will be more apparent with the aid of the description of the figures below:

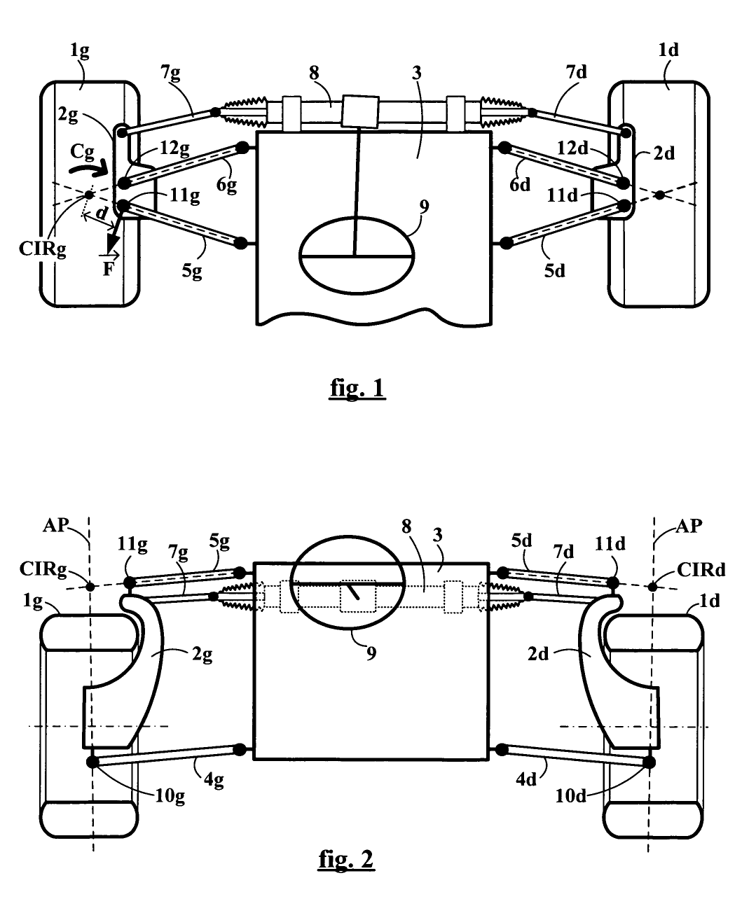

FIG. 1 shows diagrams in plan view of a vehicle equipped with a suspension having a virtual pivot point,

FIG. 2 shows diagrams in rear view of a vehicle equipped with a suspension having a virtual pivot point,

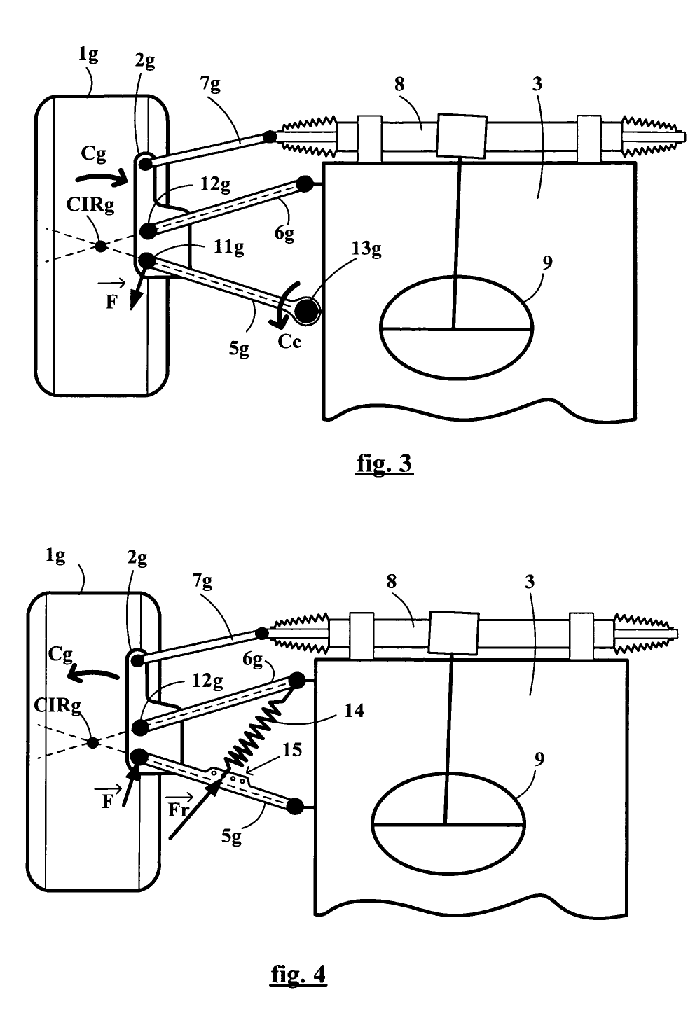

FIG. 3 shows a diagram in plan view of a first embodiment of the invention,

FIG. 4 shows a diagram in plan view of a second embodiment of the invention,

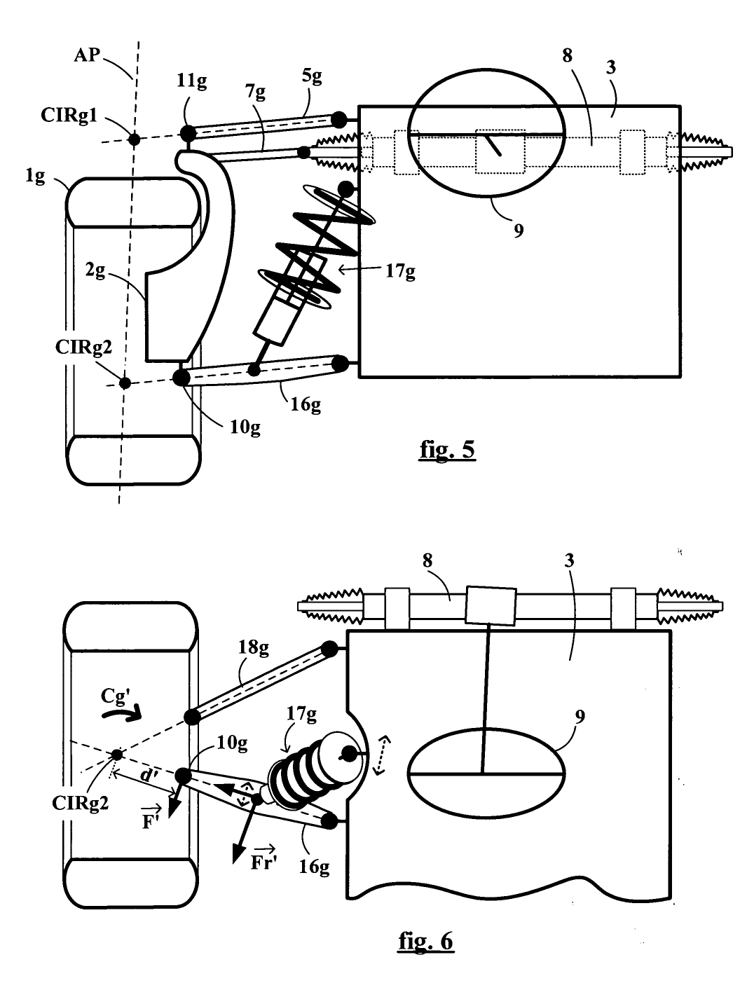

FIG. 5 shows diagrams in rear view of a third embodiment of the invention,

FIG. 6 shows diagrams in plan view of the third embodiment of the invention,

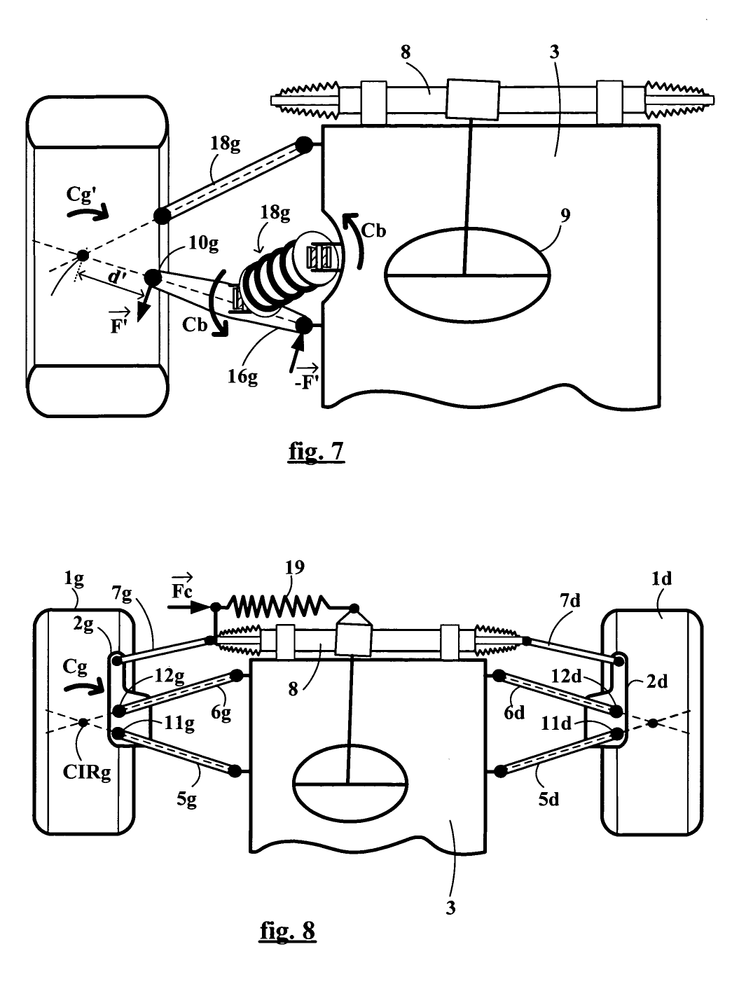

FIG. 7 shows diagrams in plan view of a variant on the third embodiment of the invention,

FIG. 8 shows diagrams in plan view of a fourth embodiment of the invention, and

FIGS. 9, 10 and 11 show diagrams of a variant on the first embodiment of the invention.

FIG. 1 is a partial diagram in plan view of a vehicle having a steering system with virtual pivot point. FIG. 2 is a rear view of the same vehicle, in section. The left wheel 1g and right wheel 1d are the front guiding wheels of the vehicle. Each wheel is borne by a respective wheel-carrier, namely a left wheel-carrier 2g and a right wheel-carrier 2d. Each wheel-carrier is connected to the body 3 by suspension elements. Shown in this example is a suspension system comprising a lower wishbone (4g on the left and 4d on the right, visible in FIG. 2), two upper arms (respectively 5g and 6g on the left and 5d and 6d on the right) and a steering connecting rod (7g on the left and 7d on the right). A steering rack 8, controlled by the steering wheel 9, synchronises the steering movements of the two wheels.

In order to describe with more precision how a steering system of this kind operates, the explanation below relates primarily to the left-hand part of the axle and the vehicle.

The degree of freedom of steering of the wheel 1g results from the fact that the lower part of the wheel-carrier 2g is connected on the one hand by a lower ball joint 10g to the lower wishbone 4g and on the other by an upper ball joint (11g and 12g) to each upper arm (5g and 6g). In a system of this kind, the pivot axis (AP) of the wheel is the axis (which in this case is substantially vertical) running through the centre of the lower ball joint 10g and the point (CIRg) where the lines of application of the upper arms intersect. This is known as a virtual pivot point, since the point CIRg does not take concrete form as an articulation, as is the case for example with the lower pivot point (lower ball joint 10g). Moreover, the position of the pivot axis is variable, since the triangle formed by the upper arms is deformed substantially during the steering movement.

The steering movement of the wheel-carrier about the pivot axis AP is controlled by the steering rod 7g. According to the invention, use is made of the fact that the ball joints 11g and 12g are at a distance (d) not equal to zero from the pivot axis (AP). This allows a torque Cg which tends to steer the wheel in the desired direction to be transmitted to the wheel-carrier 2g by way of an upper arm. For example, if the rear upper arm 5g exerts on the wheel-carrier a horizontal force \vec{F} perpendicular to the arm, this force will have the effect of generating a steering torque Cg such that Cg=|\vec{F}|*d. The force \vec{F} may have different origins, as will be seen below. By controlling the direction and intensity of the steering force \vec{F}, and as a function of the distance d, it is thus possible to control the steering torque Cg.

Because steering of the two wheels of the axle is synchronised by the steering rack 8, the effect of the steering torque Cg on side pull will be combined with that of a torque Cd which is simultaneously applied to the wheel 1d on the right if a steering torque Cd of this kind is also generated. Thus, it is the difference between the torques generated on either side of the vehicle which determines the effect on side pull.

FIGS. 1 and 2 illustrate a principle of the invention, which is to transmit to the wheel-carrier, through one of the arms defining the virtual pivot point, the equivalent of a permanent force applied to the steering wheel by the conductor to compensate or limit the effects of side pull. The effect on steering may result from forces acting in one or the other of the suspension systems of the steering axle or in both at once.

FIG. 3 shows a first embodiment of the invention. This view is similar to that in FIG. 1, except that only the left-hand part of the suspension system is shown. In this embodiment, the steering force \vec{F} originates from a torque Cc exerted by the body on the upper arm 5g about a substantially vertical axis. A torque of this kind may be achieved if for example the articulation 13g is an elastomer joint mounted with pre-tensioned torsion about its vertical axis. It is also possible to generate a torque Cc with the aid of an appropriate spring independent of the articulation. The torque Cc must be such that it corresponds to the desired force \vec{F} as a function of the length of the arm 5g. In the example illustrated, the resulting steering torque Cg will tend to steer the wheel 1g towards the inside of the vehicle (towards the right).

The embodiment shown in FIG. 4 is based on the use of a spring (in this case a tension spring 14) which exerts a force \vec{F}r on the arm 5g. Also shown are adjusting means 15 (in the form of a plurality of attachment points) allowing the direction and/or intensity of the force \vec{F}r to be modified and hence the steering force \vec{F} transmitted to the wheel-carrier 2g to be modified. It goes without saying that it is also possible to modify the steering force by selecting a different spring. This embodiment may also easily be retrofitted to an existing vehicle. The spring and fixing means in the form of collars shaped to the arms may be provided for those markets or parts of markets where correction of side pull is desired. In the example shown here, the resulting torque Cg will tend to steer the wheel 1g towards the outside of the vehicle (towards the left). This is thus the opposite of the example illustrated in FIG. 3.

Of these two embodiments of the invention, that in FIG. 4 has the additional advantage of being easy to modify, even by a mechanic after the vehicle has come into service. FIGS. 3 and 4 illustrate the case of a steering force transmitted by the rear arm 5g, but the same principle applies if the forces are applied to the wheel-carrier through the front arm 6g.

FIGS. 5 and 6 present an embodiment based on a suspension system having a lower virtual pivot point with the load taken up by a combined spring and shock absorber unit, the latter bearing against one of the lower arms defining the virtual pivot point. In the example shown, the upper pivot point is also virtual (and is identical to those in FIGS. 1 and 2) but it goes without saying that this is not a necessary condition for functioning of this embodiment. In FIG. 6, the combined unit 17g is seen to bear against the lower rear arm 16g. Because it is inclined, the combined unit exerts a force with a horizontal and a perpendicular component (\vec{F}r′) on the arm 16g. This force gives rise to the steering force F transmitted to the wheel-carrier 2g. It goes without saying that the steering force may be varied by modifying the orientation of the combined unit and hence the force \vec{F}r′. To do this, the upper point at which the combined unit is attached to the body 3 and/or the lower point at which it is attached to the arm 16g may be displaced. In the example shown, the resulting steering torque Cg′ will tend to steer the wheel 1g towards the inside of the vehicle (towards the right).

The inclination of the thrust axis of the combined unit may result from the use of an eccentric connection piece. The same or another eccentric piece may also be mounted on the suspension of the opposite wheel in an asymmetric orientation so that each wheel of the steering axle undergoes a corrective effect which is asymmetrical and thus acts in the same direction (towards the right or the left). An eccentricity in the order of 5 to 10 mm generally allows the desired effect to be achieved.

The combined spring and shock absorber unit shown here allows the illustration to be kept simple. However, the same effect is obtained if it is only a spring, or a quasi-combined unit, in other words a combined unit in which the spring bears against the combined unit with only one of its ends, with the other end bearing directly against the body. In the case of only a spring or a quasi-combined unit, it is important to take into account that the orientation of the force transmitted is separate from that of the rod, and that it is the position and direction of the force transmitted by the spring which allows the desired horizontal force \vec{F}r′ to be generated. The effect can then be achieved in a simple manner, for example by placing a spacer between the spring and the body so that the body transmits to the spring a torque about a transversely directed axis, which takes the form of a horizontal component \vec{F}r′ on the arm.

Similarly, the combined unit, quasi-combined unit or spring may bear against the front arm (18g) or against an upper arm to give a comparable effect (if this upper arm is part of an upper virtual pivot point).

The inclination of the force transmitted by the spring (or the combined unit) in order to compensate side pull may be added to the normal inclination of this force. What this means is that the combined units are sometimes inclined for example for reasons of the space occupied, but in this case, because the inclination is symmetrical with respect to the two sides of the vehicle, it has no effect on side pull.

FIG. 7 illustrates a variant on the embodiment of FIGS. 5 and 6 in which the combined unit 18g transmits a torque Cb to the lower arm. This torque, transmitted to it by the body, generates the forces (\vec{F} and −\vec{F}) at the ends of the arm 16g. This generates the steering torque Cg′ on the wheel-carrier (not shown) which, in this example, will tend to steer the wheel 1g towards the inside of the vehicle (towards the right). The torque Cb may originate in a pre-tensioned torsion in the combined unit 18g or a connection (to the arm or the body or inside the combined unit) which has a screwing effect when the vertical load is transmitted.

FIG. 8 shows another way of compensating side pull, which consists in using a spring 19 acting directly on the steering system, for example at the steering rack (8) or a steering connecting rod (7g). This way of compensating side pull may moreover be applied to any type of suspension system, including those with no virtual pivot point. This system is capable of being retrofitted.

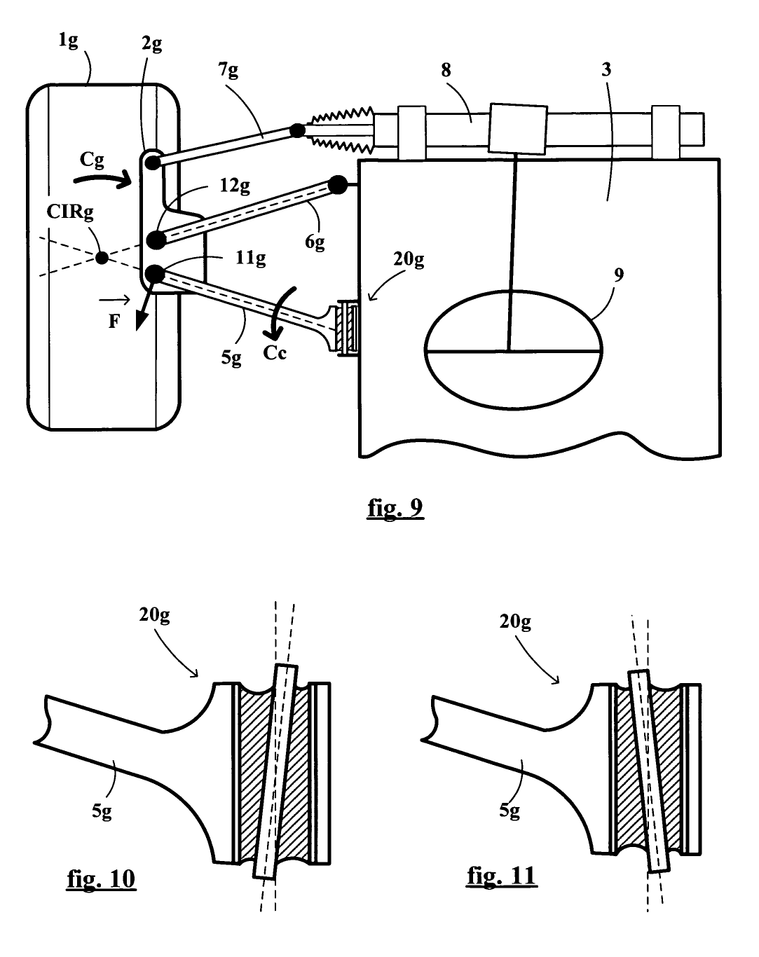

FIGS. 9, 10 and 11 show a variant on the system presented in FIG. 3 in which one of the arms is connected to the body by an elastomer joint 20g disposed along a longitudinal axis. The torque Cc transmitted by the body 3 to the arm 5g originates in a conical deforming pre-tension of the joint 20g. FIG. 10 shows the shape of the joint 20g when it is not under any tension. FIG. 11 shows the case in which the joint 20g is mounted in the arm 5g in the opposite orientation to that in FIG. 10 in order to generate an opposite torque Cc to that shown in FIG. 9. This embodiment may be retrofitted, for example to replace a neutral joint originally mounted in the vehicle.

The figures show a few examples of embodiments of the invention, but it will be clear that many other variants are possible; in particular, what has been said of the lower arms is entirely applicable to the upper arms, and vice versa.

As has been seen above, the invention may be applied to each side of the axle simultaneously, but it may also be simultaneously applied to the lower pivot point and upper pivot point of one or both of the wheels in order to achieve the desired overall behaviour of the steering system.

In the case of adapting a vehicle whereof the behaviour is known, it is also possible to modify only one side of the vehicle in order to bring about the necessary asymmetry. On the other hand, asymmetry (and hence correction of side pull) may be obtained by using identical elements on either side of the vehicle with each one generating a steering torque in the same direction (and hence asymmetrically with respect to the vehicle), with these two torques cooperating to compensate side pull.

The order of magnitude of the steering torque required may vary for an average vehicle from 2 to 10 Nm for each wheel, depending on the vehicles and the way the tyres are mounted. This correction is only useful in a straight line, that is to say when the wheels are not turned by steering or are turned only to a small extent and when the suspension is in its central position. One way of checking functioning of the system according to the invention is to place the front wheels of the vehicle on ball plates with the steering connecting rods disconnected, and to measure the static restoring torque of each wheel about its central position corresponding to a straight line.

Let us take the example of a vehicle designed for neutral behaviour when driving on the right and having symmetrical suspension systems, or in other words suspension systems not generating any steering torque overall. This vehicle is adapted for driving on the right for example by the specific way in which the tyres are chosen. This vehicle may be adapted for driving on the left in accordance with the principle of the invention by modifying either one or both of its suspension systems. In the case of modifying both sides, identical asymmetrical elements may be used on either side of the vehicle. Overall, this vehicle then needs two different sets of parts so that it can be adapted to the two types of driving. Because of the logistics of the spare parts market, for example, it is preferable to use only one kind of part in a single market or a single part of the market, and adapting the vehicle for driving on the left by changing the set of parts has this advantage.

1- A method of compensating side pull in a vehicle, the suspension system of the steering axle of the said vehicle comprising a virtual pivot point, the said method consisting in applying a steering torque (Cg) to the wheel-carrier (2g) by way of one of the arms (5g, 6g) of the said virtual pivot point.

2- A method according to claim 1, in which the steering torque (Cg) is applied to the wheel-carrier (2g) in the form of a steering force (\vec{F}) acting on the point at which the arm (5g) is articulated to the wheel-carrier (2g).

3- A method according to claim 2, in which the steering force (\vec{F}, \vec{F}′) is generated by a transverse force (\vec{F}r, \vec{F}r′) acting on the arm (5g).

4- A method according to claim 3, in which the transverse force (\vec{F}r) is transmitted to the arm (5g) by a substantially horizontal spring (14).

5- A method according to claim 3, in which the transverse force (\vec{F}r′) is transmitted to the arm (5g) by a combined spring and shock absorber unit (17g).

6- A method according to claim 2, in which the steering force (\vec{F}, \vec{F}═) is generated by a torque (Cc, Cb) acting on the arm (5g, 16g).

7- A method according to claim 1, consisting in applying a steering torque (Cg, Cd) to each wheel-carrier (2g, 2d) of the steering axle respectively, with the two steering torques preferably acting in the same direction.

8- A suspension system for a steering axle having a virtual pivot point, in which at least one of the arms of the said virtual pivot point applies to the wheel-carrier (2g) in the central position of the suspension a steering torque (Cg) which is different from the steering torque applied to the opposite wheel-carrier (2d) of the said steering axle.

9- An automotive vehicle comprising a suspension system according to claim 8.
